(19) United States
(12) Patent Application Publication
(10) Pub. No.: US 2021/0357271 A1
(43) Pub. Date: Nov. 18, 2021

(54) SYNCHRONIZATION OF DATA PROCESSING IN A CALCULATING SYSTEM

(71) Applicant: Telefonaktiebolaget LM Ericsson (publ), Stockholm (SE)

(72) Inventor: Anders WIDEBRANT, LUND (SE)

(21) Appl. No.: 17/286,152

(22) PCT Filed: Oct. 19, 2018
(86) PCT No.: PCT/EP2018/078748

§ 371 Date: Apr. 16, 2021

(51) Int. Cl. G06F 9/52; G06F 9/50

(52) U.S. Cl. CPC G06F 9/52; G06F 2209/5017; G06F 9/5027

(57) ABSTRACT

A control node and method therein to split and distribute processing task to multiple calculating nodes for synchronization of their data processing in a calculating system are disclosed. The calculating system includes a primary system input interface, a secondary system input interface, the control node and the multiple calculating nodes which are independent and perform data processing in parallel. The control node receives a second processing task from the secondary system input interface and splits the second processing task into a number of execution requests according to the number of the multiple calculating nodes. The control node queries any one of the multiple calculating nodes for a time reference retrieved from a time source common to all of the multiple calculating nodes and calculates an execute time for the execution requests to be processed in the multiple calculating nodes.

### TECHNICAL FIELD

Embodiments herein relate to methods performed in a control node, a calculating node and a calculating system for synchronization of data processing. In particular, the embodiments herein relate to distribute a processing task to multiple calculating nodes which are independent and performing data processing in parallel, and synchronize data processing in the multiple calculating nodes.

### BACKGROUND

Modern computer systems or calculating systems, especially those intended for network communications, are characterized by dual requirements to handle large data throughputs while providing low latency access. This leads to a need for synchronized parallelization, dividing data processing over many hardware instances, which may be referred to as processors or calculating nodes, operating on different parts of the same data at the same time, without introducing delays in data processing.

A key part of such parallelized processing is to avoid communication between processors or calculating nodes, since this may lead to situations where one processor must wait for the response of another before it can continue processing data. This will reduce the throughput of the system.

Synchronized parallelization is made possible by clearly defined data processing rules, specifying input data scheduled in time and resulting output data scheduled in time. In this way, data processing may be divided over parallel processors using the same processing and scheduling rules, as long as they are synchronized to the same time reference. FIG. 1 shows an example system implementing rules-based parallel data processing, where a block diagram and a graphic diagram are shown to illustrate how the system splits, processes and combines data.

When new requirements for data processing are discovered, systems that parallelize execution as described above need to update the data processing rules with new input formats that capture the new data to be processed and new output formats that specify the desired result. FIG. 2 shows an example system implementing rules-based parallel data processing with updated rules, where a block diagram and a graphic diagram are shown to illustrate how the system splits, processes and combines data. Updating the data processing rules with new input formats and new output formats is not an optimal method to handle the new requirements for data processing since it needs to change standard input and output formats and redefine standardized communication formats between systems.

### SUMMARY

It is therefore an object of embodiments herein to provide an improved method for synchronized data processing over multiple independent calculating nodes in a calculating system.

According to one aspect of embodiments herein, the object is achieved by a method performed in a control node to divide and distribute a processing task to multiple calculating nodes for synchronization of their data processing in a calculating system. The calculating system comprises a primary system input interface, a secondary system input interface, the control node and the multiple calculating nodes which are independent and perform data processing in parallel. The control node receives a second processing task from the secondary system input interface and splits the second processing task into a number of execution requests according to the number of the multiple calculating nodes. The control node queries any one of the multiple calculating nodes for a time reference retrieved from a time source common to all of the multiple calculating nodes and calculates an execute time for the execution requests to be processed in the multiple calculating nodes based on signaling times for sending each of the execution requests to respective multiple calculating nodes. The control node then sends each of the execution requests comprising the execute time to respective multiple calculating nodes.

According to one aspect of embodiments herein, the object is achieved by a control node to divide and distribute a processing task to multiple calculating nodes for synchronization of their data processing in a calculating system. The calculating system comprises a primary system input interface, a secondary system input interface, the control node and the multiple calculating nodes which are independent and perform data processing in parallel. The control node is configured to receive a second processing task from the secondary system input interface and split the second processing task into a number of execution requests according to the number of the multiple calculating nodes. The control node is further configured to query any one of the multiple calculating nodes for a time reference retrieved from a time source common to all of the multiple calculating nodes and calculate an execute time for the execution requests to be processed in the multiple calculating nodes based on signaling times for sending each of the execution requests to respective multiple calculating nodes. The control node is further configured to send each of the execution requests comprising the execute time to respective multiple calculating nodes.

According to one aspect of embodiments herein, the object is achieved by a method performed in a calculating node for synchronizing its data processing with other calculating nodes. The calculating node comprises a primary input interface and a secondary input interface and is one of multiple independent calculating nodes in a calculating system for performing data processing in parallel.

The calculating node receives an execution request comprising a specified execute time at the secondary input interface. The execution requests is one of a number of execution requests split from a processing task.

The calculating node processes the execution request at the specified execute time and selects an output time based on the specified execute time.

The calculating node provides at the selected output time the processed execution request to an output data flow.

According to one aspect of embodiments herein, the object is achieved by a calculating node for synchronizing its data processing with other calculating nodes. The calculating node comprises a primary input interface and a secondary input interface and is one of multiple independent calculating nodes in a calculating system for performing data processing in parallel. The calculating node is configured to receive an execution request comprising a specified execute time at the secondary input interface. The execution request is one of a number of execution requests split from a processing task.

The calculating node is further configured to process the execution request at the specified execute time and select an output time based on the specified execute time.

The calculating node is further configured to provide at the selected output time the processed execution request to an output data flow.

According to one aspect of embodiments herein, the object is achieved by a method performed in a calculating system. The calculating system receives a second processing task at the secondary system input interface.

The calculating system splits by the control node the second processing task into a number of execution requests according to the number of the multiple calculating nodes.

The calculating system queries by the control node any one of the calculating nodes for a time reference retrieved from a time source common to all of the multiple calculating nodes.

The calculating system calculates by the control node an execute time for the execution requests to be processed in the multiple calculating nodes based on signaling times for sending each of the execution requests to respective multiple calculating nodes.

The calculating system sends by the control node each of the execution requests comprising the execute time to respective multiple calculating nodes. The execution requests may be sent sequentially or in parallel.

The calculating system performs data processing of each execution requests at the specified execute time by the multiple calculating nodes.

The calculating system selects by the control node an output time based on the specified execute time for each calculating node.

The calculating system provides by the calculating node each processed execution requests into an output data flow at the selected output time.

According to one aspect of embodiments herein, the object is achieved by a calculating system. The calculating system is configured to receive a second processing task at the secondary system input interface.

The calculating system is further configured to, e.g. by means of the control node being configured to, split the second processing task into a number of execution requests according to the number of the multiple calculating nodes.

The calculating system is further configured to, e.g. by means of the control node being configured to, query any one of the calculating nodes for a time reference retrieved from a time source common to all of the multiple calculating nodes.

The calculating system is further configured to, e.g. by means of the control node being configured to, calculate an execute time for the second data packets to be processed in the multiple calculating nodes based on signaling times for sending each of the execution requests to respective multiple calculating nodes.

The calculating system is further configured to, e.g. by means of the control node being configured to, send each of the execution requests comprising the execute time to respective multiple calculating nodes. The execution requests may be sent sequentially or in parallel.

The calculating system is further configured to, e.g. by means of the multiple calculating nodes being configured to, perform data processing of each execution request at the specified execute time.

The calculating system is further configured to, e.g. by means of the control node being configured to, select an output time based on the specified execute time for each calculating node.

The calculating system is further configured to, e.g. by means of the calculating node being configured to, provide each processed execution request into an output data flow at the selected output time.

In other words, the embodiments herein describe a way to ensure synchronized parallel data processing without introducing peer-to-peer communication between the processing entities or calculating nodes. According to the embodiments herein, a calculating system that processes data from a primary system input interface is extended with a secondary system input interface and a control node with synchronization function that splits the processing task from the secondary system input interface onto the multiple independent processors synchronized to a common time source before combining it into a single output at an output interface.

In this way, the need to change the system's input format is avoided, thereby avoiding the need to modify the output format of adjacent systems, i.e. systems receive processing task over a primary system input interface, and the need for redefining standardized communication formats between systems.

The proposed solution also avoids the need to create an internal input format encoding the new data processing requirements, thereby avoiding the latency introduced by rewriting the input format before parallelized data processing.

Furthermore, the proposed solution may be implemented without modifying an already existing solution for parallelizing data processing between the calculating nodes or processors.

Therefore, the embodiments herein provide an improved method and apparatus for synchronized data processing over multiple independent calculating nodes in a calculating system.

### BRIEF DESCRIPTION OF THE DRAWINGS

Examples of embodiments herein are described in more detail with reference to attached drawings in which:

FIG. 1 is an example system implementing rules-based parallel data processing;

FIG. 2 is an example system implementing rules-based parallel data processing with updated rules;

FIG. 3 is an example system implementing rules-based parallel data processing with input format rewriting;

FIG. 4 is a block diagram illustrating a calculating system in which a method for synchronized parallel data processing according to embodiments herein may be implemented;

FIG. 5 is a flow chart illustrating a method performed in a control node according to embodiments herein;

FIG. 6 is a flow chart illustrating a method performed in a calculating node according to embodiments herein;

FIG. 7 is a flow chart illustrating a method performed in a calculating system according to embodiments herein;

FIG. 8 is a schematic block diagram illustrating embodiments of a control node; and

FIG. 9 is a schematic block diagram illustrating embodiments of a calculating node.

### DETAILED DESCRIPTION

Computer systems or calculating systems comprise multiple calculating nodes or processors that perform calculations on processing task they received over a standardized input interface, and produce results that they send out through a standardized output interface. The standardized input and output interfaces are hereafter refereed as the primary system input interface and the primary system output interface respectively. The task received over a standardized input interface is hereafter refereed as a standardized processing task. The new requirement for data processing is hereafter referred as a second or a new processing task. The second processing task could interrupt other processing task, e.g. the standardized processing task in the calculating system.

The term “data” herein means a chunk of data that may be divided into data-packets or data-segments that are to be distributed over several calculating nodes. A task or processing task herein may contain data and different parameters, e.g. execute time when the data shall be processed, time between every processing in case the data shall be processed more than one time, for example repetitive measurements every 15 minutes based on the same data, etc. A processing task may also contain just parameters, meaning no data. A processing task may be split and distributed to several calculating nodes.

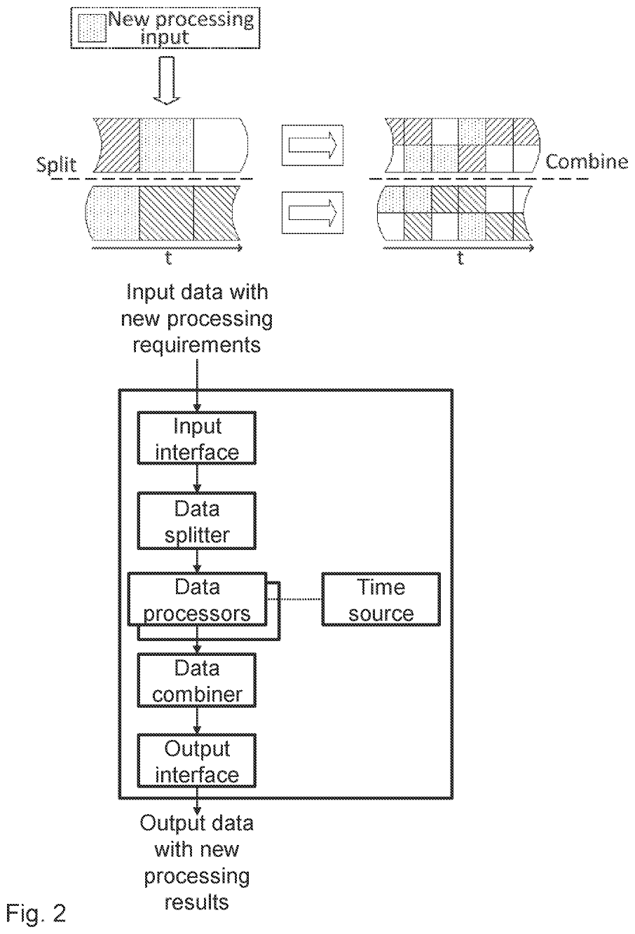

In network communications, the input format of one system often doubles as the output format of another system in an adjacent networking layer, e.g. the system that receives data over a primary system input interface as referred above. The solution to implement new requirements to update the output format of the adjacent system as shown in FIG. 2, may cause two problems:
The adjacent system may not be aware of the new requirement or have knowledge of when and how the new data processing should be applied.
The format may be standardized between systems from different vendors and changing it can require a lengthy standardization process.

To avoid the problems, the system that is to perform the new data processing may define its own internal input format, separate from the one received from the primary system input interface. The input received from the primary system input interface may then, when applicable be rewritten into the new input format, adding the information required to perform the new data processing.

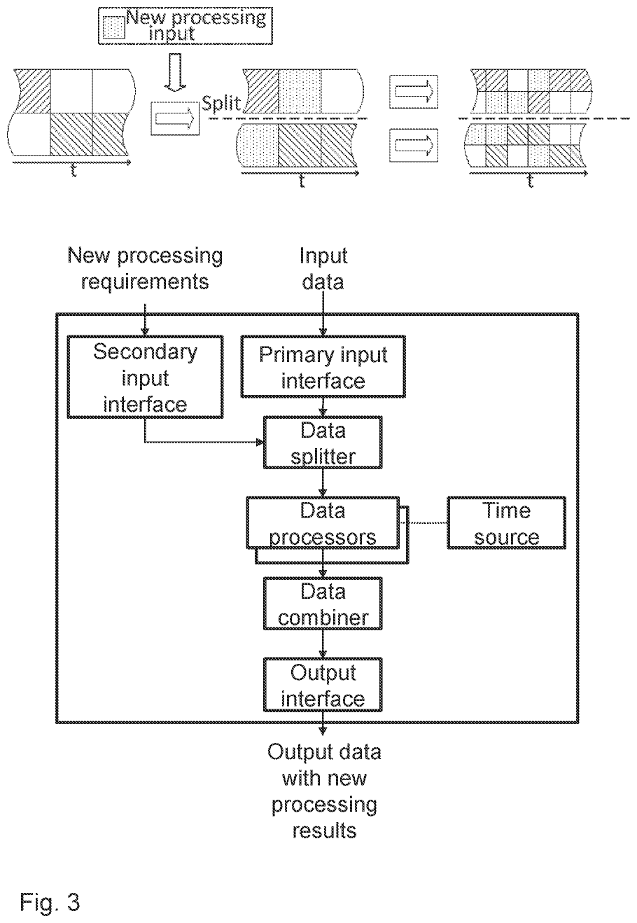

FIG. 3 shows an example system implementing rules-based parallel data processing with an internal input format rewriting, where a block diagram and a graphic diagram are shown to illustrate how the system splits, processes and combines data.

Such an internal input format transformation may however introduce latency, since the rewriting of the input format cannot be parallelized but must take place before work can be divided between processors or calculating nodes.

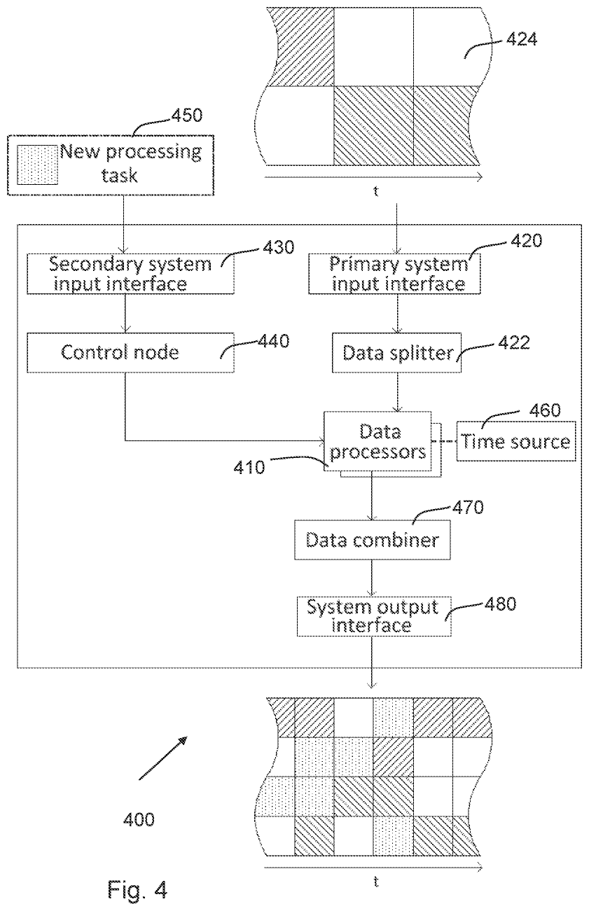

In order to perform the new data processing task efficiently, a solution according to the embodiments herein is proposed. FIG. 4 is a block diagram illustrating function blocks in a calculating system 400 in which the proposed solution for synchronization of data processing according to embodiments herein may be implemented.

As shown in FIG. 4, the calculating system 400 comprises multiple calculating nodes, i.e. data processors 410, a primary system input interface 420, a data splitter 422, a secondary system input interface 430, a control node 440 with synchronization function. The terms “calculating node”, “data processors” and “processors” may be used interchangeably hereafter. In this solution, a system that processes data from a primary input interface, i.e. standardized input interface, is extended with a secondary input interface and a control node with synchronization function that splits the new processing task from the secondary input onto the multiple independent calculating nodes synchronized to a common time source before combining it into a single output from the output interface. A calculating node works in parallel to other calculating node instances, all of which support the same input and output interfaces. The calculating nodes need not have the same implementation, but must support the same interfaces and must perform its input and output operations at a commonly timed schedule.

The data splitter 422 may split the standardized processing task 424 received at the primary system input interface 420 onto the multiple independent calculating nodes 410. The control node 440 with synchronization function is responsible for splitting the new processing task 450 received at the secondary system input interface 430 onto the data processors 410, and to provide the data processors 410 with sufficient information to perform the additional data processing in synchronization with each other. Such information may comprise, e.g. information on how to retrieve the input data, parameters for how to perform the data processing, an execute time at which the calculating node shall process and output the processed data into the output data stream. Time source 460 is common to all data processors and may provide time reference for synchronization. The processed data from the multiple data processors 410 are combined in data combiner 470 and then provided to system output interface 480. Although the control node 440 and data splitter 422 are shown as two separate nodes, their functions may be implemented in one node. That is the control node 440 may also responsible for splitting the standardized processing task 424 received at the primary system input interface 420 onto the multiple independent calculating nodes 410.

The calculating system 400 may be a centralized implementation where the data processors 410, time source 460, data combiner 470 may be in the same system. The calculating system 400 may also be a distributed implementation. For example, each of the data processors 410 may be implemented in a separate system, distributed in a cloud environment, and all data processors are synchronized to a common time source, which may also be implemented in a separate system. The data processors' output may be combined by another separate system, which provides the processed data output.

In order to handle the new processing task, there are some additional requirements on the calculating node 410. For example, the calculating node 410 may support an additional input interface through which it can receive additional requests for calculations, the result of which will affect the results on the calculating node's output interface.

The calculating node 410 may support an interface through which an external party can retrieve the current time on the calculating node, as the calculating node have retrieved it from the common time source.

The calculating node 410 may, given an additional processing request comprising a future time and some accompanying additional input data, be able to perform the necessary calculations on the additional input data and output the results on its output interface. These calculations, and the resulting output, may either be performed in addition to the calculations and output stemming from input on the calculating node's primary input interface, or replace some such calculations and output.

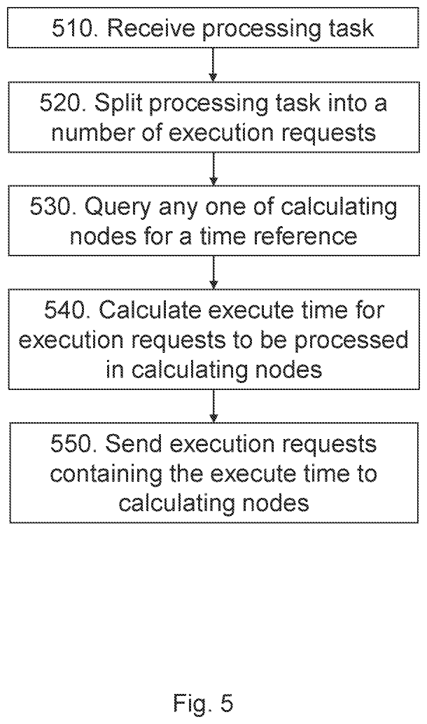

Example of embodiments of a method performed in a control node 440 to divide and distribute a processing task to multiple calculating nodes 410 for synchronization of their data processing in the calculating system 400 will now be described with reference to FIG. 5. The multiple calculating nodes 410 are independent and perform data processing in parallel. The calculating system 400 may receive a first or standardized processing task at the primary system input interface 420. In order to handle a new or second processing task, the method comprises the following actions which actions may be performed in any suitable order:

Action 510

The control node 440 receives a second processing task, e.g. an additional processing task with new format or new requirements, from the secondary system input interface 430. That is the calculating system 400 that processes data from a primary system input interface 420 is extended with a secondary system input interface 430 to receive the new processing task.

Action 520

The control node 540 splits the second processing task into a number of execution requests according to the number of the multiple calculating nodes 410. The execution request may comprise, e.g. input data or information on how to retrieve the input data, parameters for how to perform data processing, an execute time at which the calculating node shall process and output the processed data into the output data stream etc. The execution request may just comprise an execute time at which the calculating node shall process data from other source and output the processed data into the output data stream. One example may be antenna calibration, where the execution request contains an execute time to request the calculating node to process data received from the hardware that it executes on. The execution request may just comprise parameters for how to perform data processing and an execute time, the calculating node then processes data as it received on its primary input interface, but in a different way than normal or standard.

Action 530

The control node 440 queries any one of the multiple calculating nodes 410 for a time reference retrieved from a time source 460 common to all of the multiple calculating nodes 410.

Action 540

The control node 440 calculates an execute time for the execution requests to be processed in the multiple calculating nodes 410 based on signaling times for sending each of the execution requests to respective multiple calculating nodes.

For example, when the control node 440 sends each of the execution requests to the respective multiple calculating nodes in parallel, the control node 440 may increase the time reference by a period of time greater than the longest signaling time necessary for it to send the execution requests to the respective multiple calculating nodes and stores it as a virtual arrival time of each data packet. When the control node 440 sends each of the execution requests to the respective multiple calculating nodes sequentially, the control node 440 may increase the time reference by a sum of the signalling times for sending each of the execution requests to each calculating node. That is the time increment should be based on the time it will take to transmit the execution requests to all of the calculation nodes. The crucial aspect is that all of the parallel calculating nodes 410 receive not just the same execution time, but also an execution time that is in their future so they can synchronize their data processing. That is the multiple calculating node 410 perform the data processing of the received additional data at the execute time as if it had arrived at the stored virtual arrival time. In this way, it ensures that all calculating nodes 410 perform the additional data processing in synchronization with each other.

Action 550

The control node 440 sends each execution request comprising the execute time to respective multiple calculating nodes. That is the additional data to be processed and its virtual arrival time, are sent to each of the processors. As described above, the execution requests may be sent sequentially or in parallel.

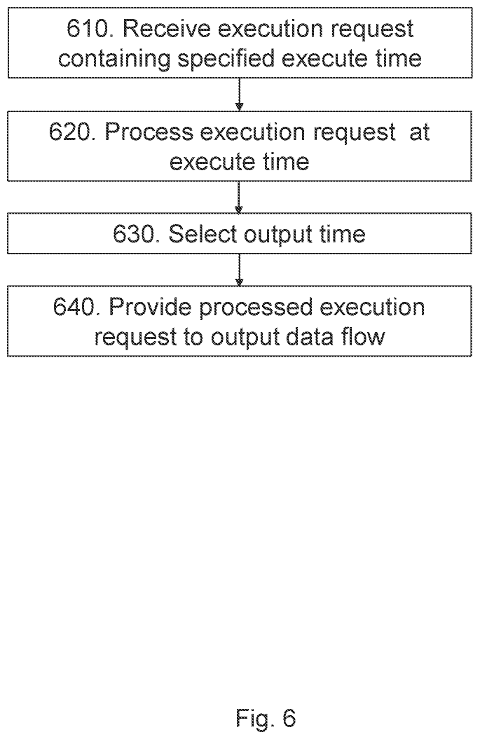

Example of embodiments of a method performed in a calculating node for synchronizing its data processing with other calculating nodes will now be described with reference to FIG. 6. The calculating node is one of the multiple independent calculating nodes 410 in the calculating system 400 for performing data processing in parallel. Each calculating node may comprise a primary input interface and a secondary input interface. The calculating node 410 may receive a first data packet at the primary input interface. The first data packet is split from a first processing task which may be a normal processing task with standard format In order to process a new processing task the method comprises the following actions which actions may be performed in any suitable order:

Action 610

The calculating node 410 receives an execution request comprising a specified execute time at the secondary input interface. The execution request is one of a number of execution requests split from a new or second processing task over the multiple independent calculating nodes. The second processing task may be an additional processing task with new data processing requirements, rules and formats. The control node 440 splits the additional processing task and sends an execution request comprising the execute time for an additional new calculation to each of the multiple independent calculating nodes.

According to some embodiments herein, in order to help define the execute time, the calculating node 410 may receive a request for a time reference from the control node 440 and send to the control node 440 a time reference retrieved from a time source common to all of the multiple calculating nodes.

Action 620

The calculating node 410 processes the execution request at the specified execute time.

Action 630

The calculating node 410 selects an output time based on the specified execute time.

When scheduling the output time for inserting or providing the results of calculations on the additional new input data into the output data flow on the output interface, the calculating node 410 must select a time that is deterministic with regards to the execute time specified in the request for the additional new calculations. The calculating node 410 may make adjustment to the time provided with the request, but only if the same adjustment would be made by all other possible parallel calculating nodes that are synchronized to the same time source and have received the same request.

Action 640

The calculating node 410 provides at the selected output time the processed execution request to an output data flow.

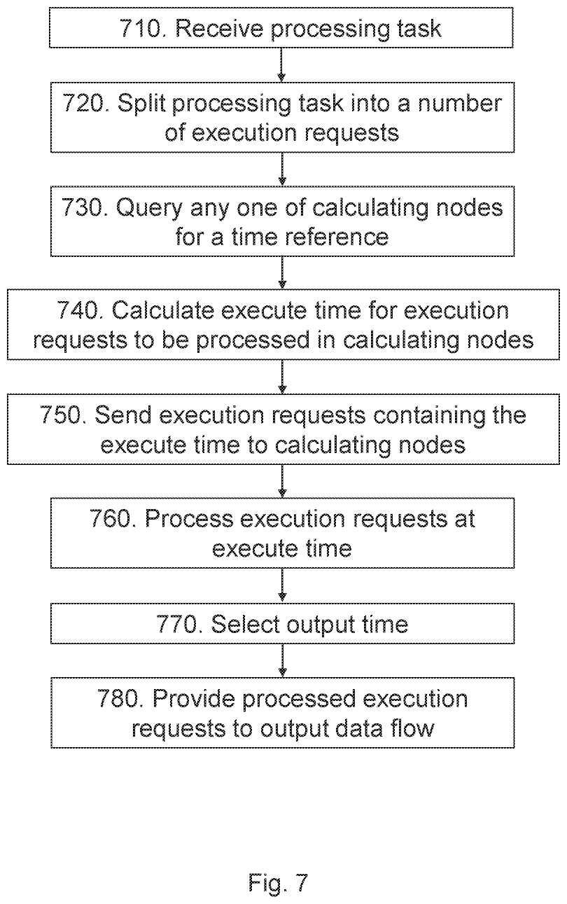

Example of embodiments of a method performed in the calculating system 400 for synchronizing data processing will now be described with reference to FIG. 7. As described above, the calculating system 400 comprises multiple independent calculating nodes 410 for performing data processing in parallel. The calculating system 400 may receive a first or standardized processing task at the primary system input interface 420. In order to process new processing task, the method comprises the following actions which actions may be performed in any suitable order:

Action 710

The calculating system 400 receives a second processing task 450 at the secondary system input interface 430.

Action 720

The control node 440 splits the second processing task into a number of execution requests according to the number of the multiple calculating nodes 110.

Action 730

The control node 440 queries any one of the calculating nodes 410 for a time reference retrieved from a time source common to all of the multiple calculating nodes.

Action 740

The control node calculates an execute time for the execution requests to be processed in the multiple calculating nodes 110 based on signaling times for sending each of the execution requests to respective multiple calculating nodes.

Action 750

The control node sends each of the execution requests comprising the execute time to respective multiple calculating nodes. The execution requests may be sent sequentially or in parallel.

Action 760

The respective multiple calculating nodes 410 processes each of the execution requests at the specified execute time.

Action 770

The control node 440 selects an output time based on the specified execute time for each calculating node.

Action 780

The calculating node 410 provides each processed execution request into an output data flow at the selected output time.

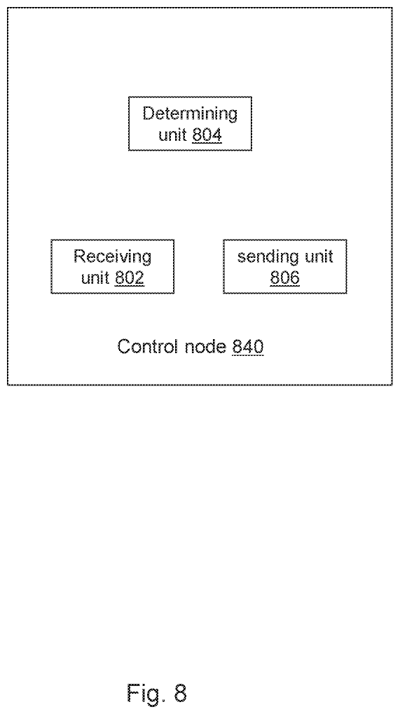

To perform the method actions in the control node 440, the control node 440 comprises circuits or units as depicted in FIG. 8. The control node 440 comprises e.g. a receiving unit 802, a determining unit 804 and a sending unit 806.

According to the embodiments herein, the control node 440 is configured to, e.g. by means of the receiving unit 802 being configured to, receive a second processing task from the secondary system input interface 430.

The control node 440 is further configured to, e.g. by means of the determining unit 804 being configured to, split the second processing task into a number of execution requests according to the number of the multiple calculating nodes.

The control node 440 is further configured to, e.g. by means of the determining unit 804 being configured to, query any one of the multiple calculating nodes for a time reference retrieved from a time source 460 common to all of the multiple calculating nodes.

The control node 440 is further configured to, e.g. by means of the determining unit 804 being configured to, calculating an execute time for the execution requests to be processed in the multiple calculating nodes based on signaling times for sending each of the execution requests to respective multiple calculating nodes.

The control node 440 is further configured to, e.g. by means of the sending unit 806 being configured to, send each of the execution requests comprising the execute time to respective multiple calculating nodes.

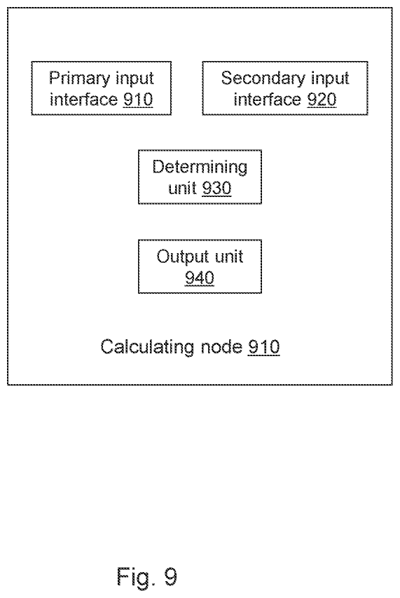

To perform the method actions in the calculating node 410, the calculating node 410 comprises circuits or units as depicted in FIG. 9. The calculating node 410 comprises e.g. a primary input interface 910, a secondary input interface 920, a determining unit 930 and an output unit 940.

According to the embodiments herein, the calculating node 410 is configured to, e.g. by means of the primary input interface 910 being configured to, receive an execution request comprising a specified execute time, wherein the execution request is one of a number of execution requests split from a second processing task received from a secondary system input interface 430 in the calculating system 400.

The calculating node 410 is further configured to, e.g. by means of the determining unit 930 being configured to, process the execution request at the specified execute time.

The calculating node 410 is further configured to, e.g. by means of the determining unit 930 being configured to, select an output time determined based on the specified execute time.

The calculating node 410 is further configured to, e.g. by means of the output unit 940 being configured to, provide at the selected output time the processed execution request to an output data flow.

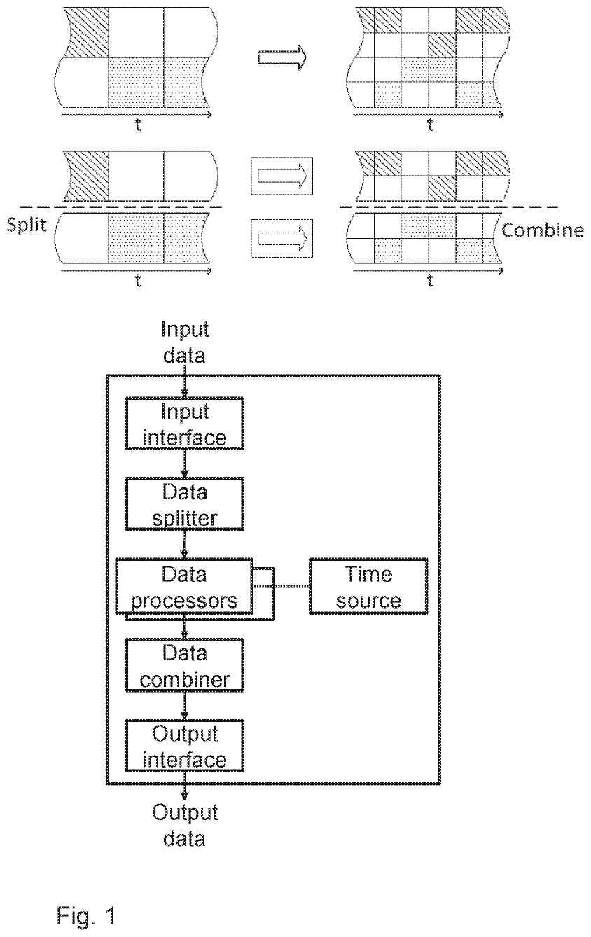

To perform the method actions in the calculating system 400, the calculating system 400 comprises circuits or units as depicted in FIG. 1.

The calculating system 400 is configured to, e.g. by means of the secondary system input interface 430 being configured to, receive a second processing task 450.

The calculating system 400 is further configured to, e.g. by means of the control node 440 being configured to, split the second processing task into a number of execution requests according to the number of the multiple calculating nodes 410.

The calculating system 400 is further configured to, e.g. by means of the control node 440 being configured to, query any one of the calculating nodes 410 for a time reference retrieved from a time source common to all of the multiple calculating nodes.

The calculating system 400 is further configured to, e.g. by means of the control node 440 being configured to, calculate an execute time for the execution requests to be processed in the multiple calculating nodes 410 based on signaling times for sending each of the execution requests to respective multiple calculating nodes.

The calculating system 400 is further configured to, e.g. by means of the control node 440 being configured to, send each of the execution requests comprising the execute time to respective multiple calculating nodes. The execution requests may be sent sequentially or in parallel.

The calculating system 400 is further configured to, e.g. by means of the multiple calculating nodes 410 being configured to, process each execution request at the specified execute time.

The calculating system 400 is further configured to, e.g. by means of the control node 440 being configured to, select an output time based on the specified execute time for each calculating node.

The calculating system 400 is further configured to, e.g. by means of the calculating node 410 being configured to, provide each processed execution request into an output data flow at the selected output time.

In summary, the embodiments herein describe a way to ensure synchronized parallel data processing without introducing peer-to-peer communication between the multiple calculating nodes. The calculating system 400 that processes data from a primary system input interface is extended with a secondary system input interface and a control node with synchronization function that splits the processing task from the secondary system input interface onto the multiple independent calculating nodes synchronized to a common time source before combining it into a single output at an output interface.

In this way, the need to change the system's input format is avoided, thereby avoiding the need to modify the output format of adjacent systems and the need for redefining standardized communication formats between systems.

The proposed solution also avoids the need to create an internal input format encoding the new data processing requirements, thereby avoiding the latency introduced by rewriting the input format before parallelized data processing.

Furthermore, the proposed solution may be implemented without modifying an already existing solution for parallelizing data processing between the multiple calculating nodes.

Those skilled in the art will appreciate that the receiving unit 802, the determining unit 804 and the sending unit 806 described above in the control node 440 may be referred to one circuit/unit, a combination of analog and digital circuits/units, one or more processors configured with software and/or firmware and/or any other digital hardware performing the function of each circuit/unit.

Those skilled in the art will appreciate that the primary input interface 910, the secondary input interface 920, the determining unit 930 and the output unit 940 described above in the calculating node 440 may be referred to one circuit/unit, a combination of analog and digital circuits/units, one or more processors configured with software and/or firmware and/or any other digital hardware performing the function of each circuit/unit.

When using the word “comprise” or “comprising” it shall be interpreted as non-limiting, i.e. meaning “consist at least of”.

The embodiments herein are not limited to the above described preferred embodiments. Various alternatives, modifications and equivalents may be used. Therefore, the above embodiments should not be taken as limiting the scope of the invention, which is defined by the appended claims.

1. A method performed in a control node to split and distribute processing task to multiple calculating nodes for synchronization of their data processing in a calculating system, wherein the calculating system comprises a primary system input interface, a secondary system input interface, the control node and the multiple calculating nodes which are independent and perform data processing in parallel, the method comprising:
receiving a second processing task from the secondary system input interface;
splitting the second processing task into a number of execution requests according to the number of the multiple calculating nodes;
querying any one of the multiple calculating nodes for a time reference retrieved from a time source common to all of the multiple calculating nodes;
calculating an execute time for the execution requests to be processed in the multiple calculating nodes based on signaling times for sending each of the execution requests to respective multiple calculating nodes; and
sending each of the execution requests comprising the execute time to respective multiple calculating nodes.

2. The method according to claim 1, wherein calculating an execute time is performed by incrementing the time reference by a period of time greater than the longest signaling time necessary for sending the execution requests in parallel to the respective multiple calculating nodes.

3. The method according to claim 1, wherein calculating an execute time is performed by incrementing the time reference by a period of time greater than a sum of the signalling times for sending each execution request to each calculating node sequentially.

4. A method performed in a calculating node for synchronizing its data processing with other calculating nodes, wherein the calculating node comprises a primary input interface and a secondary input interface and is one of multiple independent calculating nodes in a calculating system for performing data processing in parallel, the method comprising:
receiving an execution request comprising a specified execute time at the secondary input interface, wherein the execution request is one of a number of execution requests split from a second processing task received from a secondary system input interface in the calculating system;
processing the execution request at the specified execute time;
selecting an output time based on the specified execute time; and
providing at the selected output time the processed execution request to an output data flow.

5. The method according to claim 4, further comprising:
receiving a request for a time reference from a control node; and
sending to the control node a time reference retrieved from a time source common to all of the multiple calculating nodes.

6. (canceled)

7. (canceled)

8. A calculating node for synchronizing its data processing with other calculating nodes, wherein the calculating node comprises a primary input interface and a secondary input interface and is one of multiple independent calculating nodes in a calculating system for performing data processing in parallel, the calculating node is configured to:
receive an execution request comprising a specified execute time at the secondary input interface, wherein the execution request is one of a number of execution requests split from a second processing task received from a secondary system input interface in the calculating system;
process the execution request at the specified execute time;
select an output time based on the specified execute time; and
provide at the selected output time the processed execution request to an output data flow.

9. (canceled)
